(19) United States
(12) Patent Application Publication
(10) Pub. No.: US 2013/0041742 A1
(43) Pub. Date: Feb. 14, 2013

(54) CONTROL METHOD AND CORRESPONDING SYSTEM FOR OBTAINING COUPONS THROUGH COUPON TERMINAL

(71) Applicants: Yibin Zhang, Shanghai (CN); Liang He, Shanghai (CN); Zhenyu Ying, Shanghai (CN); Huadong Chen, Shanghai (CN)

(72) Inventors: Yibin Zhang, Shanghai (CN); Liang He, Shanghai (CN); Zhenyu Ying, Shanghai (CN); Huadong Chen, Shanghai (CN)

(73) Assignee: VELO INFORMATION TECHNOLOGY (SHANGHAI), INC., Shanghai (CN)

(21) Appl. No.: 13/574,308

(22) PCT Filed: Jan. 21, 2011
(86) PCT No.: PCT/CN11/00099

§ 371 Date: Oct. 24, 2012

(30) Foreign Application Priority Data
Jan. 21, 2010 (CN) 201010023084.2

(51) Int. Cl. G06Q 30/02

(52) U.S. Cl. 705/14.36; 705/14.37

(57) ABSTRACT

A control method for obtaining a coupon by a coupon terminal is disclosed. The method includes: step a. receiving request information for obtaining a coupon; step b. providing a coupon according to the request information; step c. deducting points corresponding to provided coupon from an account corresponding to the request information; step d. adaptively recording the provided coupon in a database; and step e. performing a statistics analysis on the provided coupon stored in the database. A control apparatus for obtaining a coupon by a coupon terminal is also disclosed. According to the present technical solution, by using the existing internet technology and RFID technology, a user may conveniently obtain required coupons by the coupon terminal, and download and print the coupons.

### TECHNICAL FIELD

The present invention relates to control systems for information issuing, more particularly to an information issuing system for providing coupons, and specifically to a control method and corresponding control apparatus for issuing coupon information to users by a coupon terminal.

### BACKGROUND

Nowadays, with the improvement of living standards, electronic coupons are constantly updating, from original single function such as catering, entertainment or leisure to the present one-stop style integrating eating, drinking and pleasure-seeking. Respective businesses launch a variety of coupons to attract more customers, and one-stop electronic coupons usually draw more attentions because they gather powers of various businesses. Thus, platforms providing coupons such as dianping.com (www.dianping.com), which make profits by charging service fees from participating businesses, start to emerge. Customers may gain the latest information regarding discounts and promotions offered by businesses through the internet and download their desired coupons from the web. This may advertise for respective businesses to boost their popularities, and meanwhile the provided coupons may bring tangible benefits to customers.

On the other hand, with the tide set off by the Radio Frequency Identification (RFID) technology across the world recently, business giants including Wal-Mart, Procter & Gamble (P&G), Boeing Co., etc. are all positively promoting the application of RFID in manufacturing, logistics, retail, transportation, and so on. In the domestic region, the RFID technology has started to be applied in various fields. For example, transportation cards which we use when going out have been widely applied to transportation tools such as buses, taxis and subways; the RFID technology may be used to automatically identify automobiles passing highway toll stations, payment being completed while automobiles passing toll stations; in addition, this technology is also applied in the fields such as identifying persons who enter or leave specific channels, and security check.

In combination with the RFID technology, obtaining coupons by a coupon terminal will bring great conveniences to users, and meanwhile offer invisible commercial opportunities to businesses as well. However, there exists no well-developed technical solution for providing coupons in this way.

### SUMMARY OF THE INVENTION

Aiming at the defects of the prior arts, the present application provides a control method and apparatus for providing a coupon to users by a coupon terminal in combination with the RFID technology and the internet technology.

According to one aspect of the present application, a control method for obtaining a coupon by a coupon terminal is provided, characterized by comprising: a. receiving request information for obtaining a coupon; b. providing a coupon according to the request information.

According to another aspect of the present application, a control apparatus for obtaining a coupon by a coupon terminal is provided, characterized by comprising: a first receiving means configured to receive request information for obtaining a coupon; and a first sending means configured to provide a coupon according to the request information.

In the present application, in combination with the existing internet technology and RFID technology, a user may obtain required coupons by a coupon terminal, and download and print the coupons. This may bring conveniences to users for obtaining coupons, and meanwhile offer invisible commercial opportunities to businesses.

### BRIEF DESCRIPTION OF THE DRAWINGS

Other features, objects and advantages of the present invention will become more apparent from detailed descriptions on non-restrictive embodiments with reference to the following figures:

FIG. 1 depicts a flowchart of a control method for obtaining a coupon by a coupon terminal according to a first embodiment of the present invention;

FIG. 2 depicts a flowchart of a control method for obtaining a coupon by a coupon terminal according to a second embodiment of the present invention;

FIG. 3 depicts a flowchart of a control method for obtaining a coupon by a coupon terminal according to a third embodiment of the present invention;

FIG. 4 depicts a network topology for obtaining a coupon by a coupon terminal according to a specific embodiment of the present invention;

FIG. 5 depicts a schematic of a data table for storing information in a background process system of the coupon terminal according to a specific embodiment of the present invention;

FIG. 6 depicts a structure diagram of a control apparatus for obtaining a coupon by a coupon terminal according to a specific embodiment of the present invention; and

FIG. 7 depicts a detailed structure diagram of a first generation means (or a second generation means) in a control apparatus for obtaining coupons by a coupon terminal according to a specific embodiment of the present invention.

### DESCRIPTION OF THE EMBODIMENTS

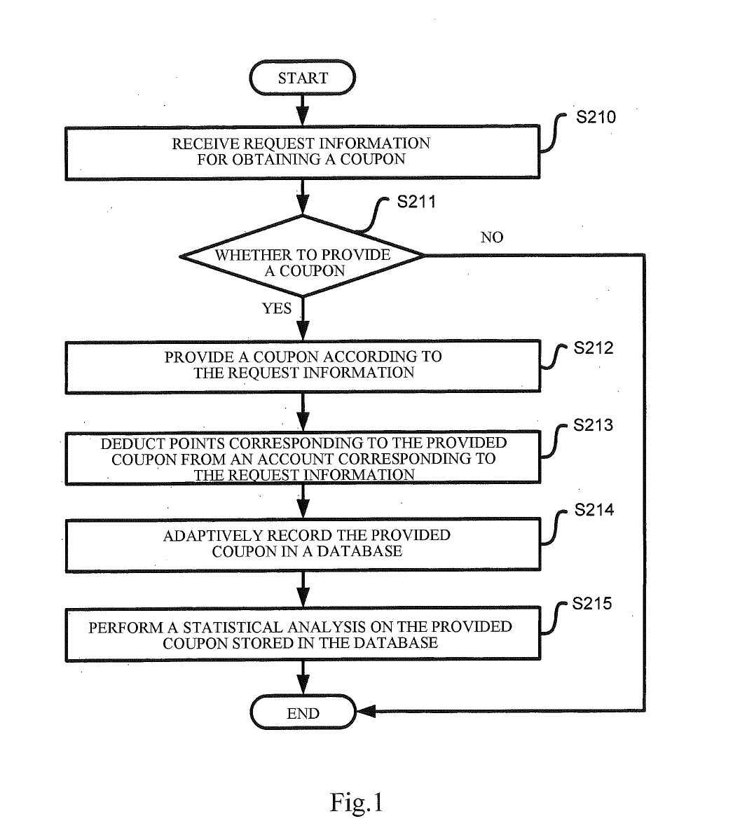

FIG. 1 depicts a flowchart of a control method for obtaining a coupon by a coupon terminal according to a first embodiment of the present invention. Specifically, step S210 is firstly performed to receive request information for obtaining a coupon. Preferably, the request information is sent by a user (or referred to as a customer, a consumer), and accordingly the coupon terminal receives the request information. For example, by menus provided by the coupon terminal, the user selects a key corresponding to a business from which a coupon is to be obtained. Upon the user pressing the key, the request information is sent to a background process system of the coupon terminal, and then the background process system searches a database for appropriate coupon information according to the received request information. For another example, the request information is sent by manners adaptive with a receiving terminal equipped for the coupon terminal. For example, the user may register online and log into the coupon website, and meanwhile activate the receiving terminal (e.g., a mobile terminal with a radio frequency function or an electronic tag) equipped for the coupon terminal. Then, the user may search coupons provided by respective businesses on the website, and select required coupons and add them into a designated favorite. One of ordinary skill in the art appreciates that, the registered number of the user on the website needs to match the account used for activating the receiving terminal so that the coupon information may be recorded in the user's receiving terminal while he adds the coupon information into the favorite, and then upon the user conducting identification at the coupon terminal using the receiving terminal and selecting to display the collected coupon information, the request information is sent to the background process system.

Then, step S211 is performed to judge whether to provide a coupon according to the request information. Any one of the following conditions may be taken as the judgment basis: judging whether a requester corresponding to the request information exists in particular data list according to the request information, judging whether a requester corresponding to the request information belongs to a particular group according to the request information, judging whether a requester corresponding to the request information is a person in a particular age bracket according to the request information, judging whether a requester corresponding to the request information is of a particular gender according to the request information, and so on.

For example, Kentucky Fried Chicken (KFC) launches a series of coupons, some of which are offered aiming at users who are QQ members. Thus, in the step S211, whether the user sending the request information is a QQ member is judged. One of ordinary skill in the art appreciates that, on the coupon website, after the user attaching the account on the coupon website with his QQ number (note: the specific attaching procedure may be realized according to the operation procedures and prompts on the website and detailed descriptions are omitted), he may enjoy exclusive coupons for QQ members on the coupon website, and the background process system of the website adds the user into a QQ member list, i.e., the particular data list, or sets a particular identifier for the user. For example, the identifier for an ordinary user may be set as 0 and the identifier for a particular user (e.g., the above QQ membership user) may be set as 1 in a database. Further, the background process system may record the information of the identifiers in the electronic tag, and when the user sends the request information for obtaining a coupon to the coupon terminal, the information of the identifiers recorded in the electronic tag will be included in the request information.

Such judgment procedure may be realized by the following steps: sending the identity information to a particular server to request the particular server to judge whether the user is a QQ member, and determining whether the user is a QQ member according to feedback information from the particular server. One of ordinary skill in the art appreciates that, the particular server may be a Tencent QQ server; in another modified example, the identity information of the user may be stored in a database of the background process system of the coupon terminal or in a memory of the coupon terminal itself; when the user sends the request information to the background process system, the background process system obtains the identity information of the user from the memory and judges whether the user is a QQ member.

For another example, the coupon website may classify all registered users, for example, according to account points of the users. Those with points less than 10,000 are set as ordinary users, and those with points greater than or equal to 10,000 are set as senior users, i.e., dividing all the users into different groups according to certain standards. Here, identifiers may be used in the database to divide different groups. Further, the coupon website may provide different coupons aiming at ordinary users and senior users, and then when reading the information in the user's electronic tag card, the coupon terminal may identify the group which the user belongs to according to the identifier. When the user exists in the particular group (e.g., a senior user), exclusive coupons for senior users are provided to him; if the user does not exist in the particular group, particular coupons are not provided to him.

In addition, whether to a provide coupon to the requester may also be judged according to his conditions such as age and gender. One of ordinary skill in the art may realize such modified example in combination with prior art and the above embodiments: for example, a mobile terminal used by the requester has already been attached with the age of the requester, which procedure may be completed by personal information submitted by the requester being entered into a database of the background process system when the requester registers the mobile terminal, so that the control apparatus provided by the present invention may obtain the age of the requester by the above database or similar storage apparatus when the requester sends the request information in the above step S210 using the mobile terminal. Further, coupon information to be issued may be determined according to the age of the requester. Similarly, the procedure of providing a coupon according to genders may be realized by referring to the present example. This does not influence the substantive contents of the present invention, and detailed descriptions thereof are omitted.

Next, step S212 is performed to provide a coupon according to the request information. Specifically, according to the judgment in the above step S211, the coupon information which may be provided to the requester is displayed on a display screen of the coupon terminal, and then the user may print the coupon from the terminal. Further, if the user prefers not to print the coupon for now, he may select to send the coupon to the electronic tag card of the user. Specifically, one of ordinary skill in the art appreciates that, the identification information of the electronic tag card used by the user corresponds to the registered account, and the corresponding is unique, and then when the user puts the electronic tag card within a sensing area for identification, the background process system of the terminal can read the identification information of the electronic card, and all the operations before the user selects a “cancel” key are recorded in a data record under the identification information; thus, when the user presses a “Send the Coupon to the Electronic Tag Card” key, the background process system can send the coupon to an electronic tag card with corresponding identification information. One of ordinary skill in the art appreciates that, preferably, this step is completed directly by the coupon terminal, i.e., the coupon terminal may directly determine or generate coupons and provide them to the user according to the above manners. In another modified example, the coupon terminal firstly sends the request information for a coupon to a background server, and receives feedback information (including specific information or prompt information of a coupon) provided by the background server to determine or generate coupons and provides them to the user according to the above manners. Such procedures may be completed by referring to the above operation procedures, and detailed descriptions thereof are omitted.

Then, step S213 is performed to deduct points corresponding to the provided coupon from an account corresponding to the request information. Specifically, the step corresponds to some particular coupons. For example, the coupon website launches some special coupons for which points need to be deducted, and then when the user selects to print the coupon or send the coupon to his electronic tag card, the background process system of the coupon terminal may deduct corresponding points from the user's electronic tag card account according to a preset point value for obtaining the coupon. One of ordinary skill in the art appreciates that, in the database of the background process system, information regarding coupons for which points need to be deducted may be stored separately in a data table, and the points value to be deducted for the coupon may be recorded in the data table; upon the user's selection of the coupon, modification statements in database languages are employed to deduct corresponding coupon points from the user's points, and the points left after deduction are recorded in the user's point account; further, when the points owned by the user are not sufficient to compensate for the required points for the coupon, it may be prompted on the terminal that the user can not obtain the coupon for now.

Next, step S214 is performed to adaptively record the provided coupon in a database. Specifically, one of ordinary skill in the art appreciate that, every coupon corresponds to an unique number, and the coupons may be recorded in the database of the background process system according to the numbers. For example, the number of one coupon is “0908280143” and then the number may be used as an ID number to identify the coupon information in the database. Further, for the convenience of information recording, the former six digits of the coupon number provides time information of the coupon (e.g., 090828xxxx indicates that the coupon is provided on Aug. 28, 2009), the latter digits indicate that the coupon is the N-th coupon on that day (e.g., xxxxxx0143 indicates the 143rd coupon), and then respective data tables may be created in the database according to different time and dates. For example, a data table ‘090828’ is created to record the coupons provided on Aug. 28, 2009, and the last four digits (0143) of the coupon numbers may be recorded as the ID numbers in the data table. Thus, when the coupons are recorded, information regarding the former six digits of the coupon numbers may be intercepted by employing database operation statements and selected to be recorded in a corresponding data table, and the coupons may be ordered according to the last four digits.

Then, step S215 is performed to statistically analyze the provided coupons stored in the database. Specifically, in the database in the above step S214, every piece of coupon recording information includes a statistics field, and 1 is added into the data in the statistics field every time the coupon is provided. One of ordinary skill in the art appreciates that, the procedure may be realized by related statistics function in the database, for example, the count function may be used to count the total of the number of times, and further, respective coupons after the counting on the number of times may be ordered in the data table according to the number of times in descending order, so as to conveniently analyze which coupons are more widely preferred by customers and to provide reference information to businesses for later launch of new coupons.

One of ordinary skill in the art appreciates that, the above steps may be applied in many situations. Preferably, the present embodiment is applied in the situations of coupon terminals. For example, if some coupon terminals in compliance with the control method provided by the present invention are set in public places, then on the coupon terminals at subway stations, shopping malls, stores, and so on, a user may obtain information service using an access card (e.g., a corresponding RFID card) corresponding to these terminals. One of ordinary skill in the art appreciates that, the access card is an electronic tag using the RFID technology. When a user puts the access card within a sensing area of the coupon terminal, data information in the access card of the user may be read by radio frequency signals. Specifically, the access card includes a radio frequency module including a radio frequency antenna and a radio frequency card. The procedure of reading information from the radio frequency card may be completed by the radio frequency antenna. Further, after completion of reading information from the access card, the coupon terminal displays the read information on the display screen near the sensing area. For example, the user may select a “My Coupon” option on the terminal (note: it is premised that the terminal provides this option, and it may vary depending on the options provided by the terminal), and when the access card of the user stores coupon information of some businesses, the coupon information of the businesses can be displayed on the display screen. For another example, the user may select different businesses on the coupon terminal. Specifically, upon the user discretionarily selecting one of the businesses, all coupon information of the selected business will be displayed on the display screen, and the user may view the information of every coupon by selection buttons at lower portion of the terminal. One of ordinary skill in the art appreciates that, every coupon terminal has a background process (service) system (see the network topology depicted in FIG. 4) including a database configured to store coupon information of respective businesses on the terminal. Specifically, different businesses may be identified by different ID numbers in the database, and upon the user selecting one of the businesses, information regarding the ID number of the business will be sent to the background process system, and then corresponding business information may be searched for according to the ID number and related information may be read by database query statements.

In a modified example of the present embodiment, the step S213 may be omitted. For example, for many of the coupons provided on the coupon website, no point is needed to be deducted, and if the user obtains the provided coupon, no point will be deducted from the account of corresponding user.

In a modified example of the present embodiment, the step S214 may also be omitted, i.e., the provided coupon is not adaptively recorded to the database in the background process system. For example, when the user directly selects coupon information of one or more businesses on the coupon terminal and downloads and prints them, the background process system may not record the provided coupon information in the database corresponding to the user.

In the present embodiment, the step S215 and other steps are not performed synchronously. For example, the background process system of the coupon terminal may be set as performing statistics on the coupon information during the past 24 hours within the time period from 00:00 to 2:00 every day. The statistics procedure may be completed at a particular time and thus is not in real time. Further, within the time period for performing statistics, the background process system may enter the provided coupon information during the past 24 hours into a designated database for statistical analysis so as to ensure that the user may continue to send the request information for obtaining a coupon to the coupon terminal and download and print the coupon in this time period. This does not influence the substantive contents of the present invention, and detailed descriptions thereof are omitted.

In another modified example of the present embodiment, the step S215 may also be omitted. Specifically, as mentioned above, the statistical analysis procedure may be completed at a particular time or a particular time period and is not performed in real time, and thus the step may be omitted in the specific procedure of the embodiment.

In another modified example of the present embodiment, all of the steps S213, S214 and S215 may be omitted at the same time or some of them may be omitted. Specifically, when all of the steps S213, S214 and S215 are omitted, the procedure depicted in FIG. 1 may be considered as the simplest embodiment, and for example, may be applied in the situations where a user directly selects one or more businesses on the coupon terminal by a mobile terminal or an electronic tag with a radio frequency function to obtain coupon information and download and print the coupon. For the implementation procedure, please refer to the above specific embodiments. In addition, when some of the above steps are omitted, the above corresponding modified examples may be referred to and detailed descriptions thereof are omitted.

In another modified example of the present embodiment, by the step S210, the request information for obtaining a coupon is received. Specifically, a user may send the request information for obtaining a coupon on the coupon website. For example, the user logs into “My Coupon Account” on the website and search coupon information of businesses from the website and adds required coupon information into “My Coupon Account”. One of ordinary skill in the art appreciates that, on the coupon website, there is an “Add Into My Coupon” operation option near the coupon information of respective businesses. Upon the user's selection of the operation option, the background process system receives the request information for obtaining a coupon from the user and then adds the coupons selected by the user into “My Coupon” account. Preferably, a maximum of 30 coupons may be stored in the user's account. Specifically, web developers may write corresponding scripting languages for the operation option to realize the specific procedure and detailed descriptions thereof are omitted.

Further, after the user puts the electronic tag card on the coupon terminal for identification and selects “My Coupon” key on the terminal, the background process system reads the coupon information of the user in “My Coupon” account and displays the read results on the display screen of the terminal. The user may print the coupon as needed.

Further, every one of the coupons stored by the user in “My Coupon” may be printed only for once. Specifically, the background process system may judge the number of times for printing the coupon according to whether the user selects the “My Coupon” key on the terminal, and when the user exceeds a preset number of times for printing, the background process system may send prompt information to the terminal to prompt that the user cannot continue to print the coupon.

Further, one of ordinary skill in the art appreciates that, the “points” in the step S213 may be various kinds of points. For example, the points may be electronic money in an electronic wallet, i.e., electronic money corresponding to the coupon is deducted for every printing of the coupon, which equals to buying the coupon with money. One of ordinary skill in the art appreciates that different situations may be set according to different embodiments. For example, some coupons need to be bought with money while some coupons may be bought with points not money, and some coupons may be obtained without point deduction. This does not influence the substantive contents of the present invention, and detailed descriptions thereof are omitted.

Further, one of ordinary skill in the art appreciates that, information regarding an appointed coupon in an account corresponding to the requester may be held in the account corresponding to the requester by any one of the following manners. For example, the requester actively requests the coupon. Specifically, a user (requester) may select a key corresponding to the business from which the coupon is obtained by menus provided by the coupon terminal. Upon the user pressing the key, the request information is sent to the background process system of the coupon terminal, and then the background process system searches for suitable coupon information from the database according to the received request information and sends the coupon to the account corresponding to the requester. For another example, the background process system may push the coupon to the account corresponding to the requester. For example, the business may launch some activities during holiday seasons to offer the registered users on the coupon website some coupons for free, and then the business may send the coupons to be pushed to the user's account directly by the background process system. For another example, alternatively, the requester automatically obtains the coupon when submitting registration information, for example, the coupon website may provide the newly registered users some ordinary coupons. Specifically, after a new user registers successfully, the background process system automatically sends coupons to an account corresponding to the new user. One of ordinary skill in the art may realize the above function by writing related control program of the background process system, and detailed descriptions thereof are omitted.

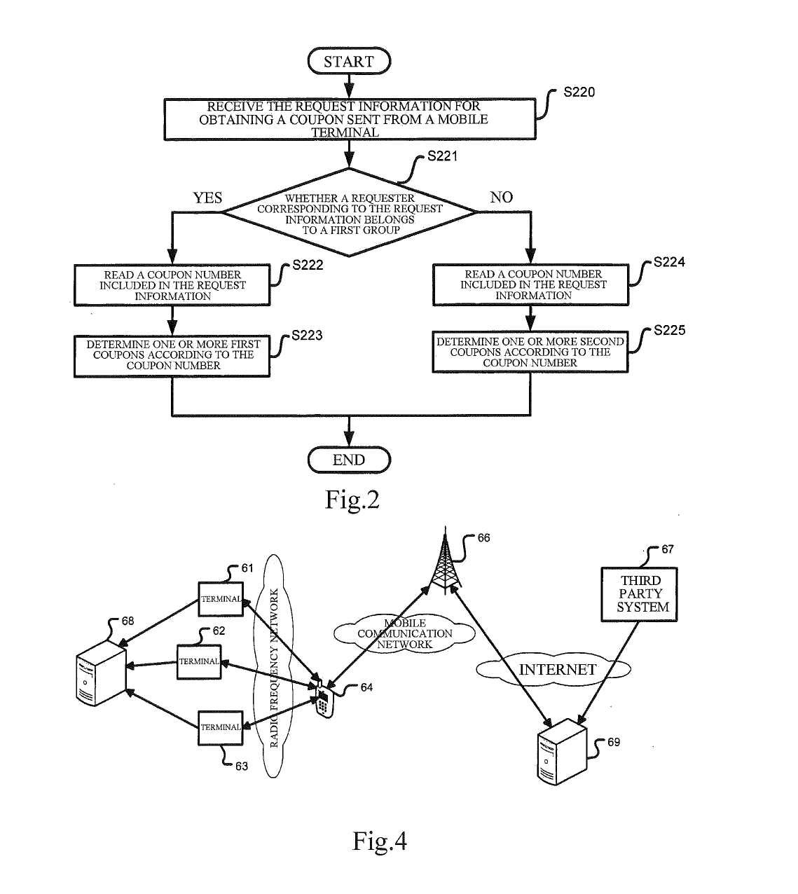

FIG. 2 depicts a flowchart of a control method for obtaining a coupon by a coupon terminal according to a second embodiment of the present invention. Specifically, step S220 is firstly performed to receive request information for obtaining a coupon sent from a mobile terminal. One of ordinary skill in the art appreciates that, the mobile terminal includes a radio frequency module which has unique identification information. For example, taking a mobile phone with a radio frequency function as an example, one of ordinary skill in the art appreciates that the SIM card number may be attached with the radio frequency apparatus. Specifically, mobile phone service providers may provide related services for users, for example, professionals at mobile phone service stations handle relevant attachment procedures for users or the users my realize the attachment by editing a short message and sending it to a designated service code and following relevant operation procedure. Detailed descriptions are omitted. Then, after the user registers on corresponding websites or coupon terminals that provide coupon printing services using the mobile phone number, he may conduct identification at the coupon terminal by the radio frequency module in the mobile phone; after the coupon terminal completes information reading, the user may discretionarily select one or more businesses on the terminal, i.e., sending the request information for obtaining a coupon to the background process system, and then the background process system reads the coupon information of the businesses from the database and displays it on the display screen.

Then, step S221 is performed to judge whether the requester corresponding to the request information belongs to a first group according to the request information. Specifically, the first group here may be defined by the coupon website itself. For example, all the users registered on the website may be classified, preferably according to points in the accounts of users. For example, users with a points value in account greater than or equal to 10,000 may be divided into a first group, users with a points value in account greater than or equal to 5,000 but less than 10,000 may be divided into a second group, users with a points value in account less than 5,000 may be divided into a third group, and so on, and in the database of the background process system, all the users may be identified according to the above classification, for example, numbers 1, 2, 3, . . . , N representing the first group, the second group, the third group, . . . , the N-th group. One of ordinary skill in the art appreciates that, the specific procedure may be realized by employing structure control statements such as switch . . . case . . . ; further, when the points in the user's account of the user changes, data updating statements (e.g., update statement) may be employed to update the user's point information in the database. Then, when the user conducts identification by putting the electronic tag card at the coupon terminal, the background process system of the coupon terminal reads the user's related information in the electronic tag card and obtains the group information to which the user belongs.

When the user belongs to the first group, step S222 is performed to read a coupon number included in the request information. Preferably, the step is applied into the situation where the user selects “My Coupon”. When the user selects the “My Coupon” key on the coupon terminal, the background process system of the terminal reads the coupon information stored by the user in an access card. Specifically, the background process system reads the number information of the coupon and searches for corresponding coupons from the database according to the number, and further selects the coupons which may be provided to the users in the first group from all the searched coupons. One of ordinary skill in the art appreciates that, the procedure may be realized by database operation statements, for example, the statement select . . . with a selection conditional clause where . . . appended may be employed to realize the procedure. It is a second preference that the step may be applied into the situation where a user selects any one or more businesses directly on a coupon terminal. Specifically, when the user clicks a key corresponding to a certain business, the background process system receives the information of the business selected by the user, and searches the database for a data table corresponding to the business, and then selects from the data table the coupons which may be provided to the users in the first group.

Then, step S223 is performed to determine one or more first coupons according to the coupon number. Specifically, according to the search results of the above step S222, the first coupons may be provided are determined, and the background process system may also determine the number of pieces which may be provided to the user according to the coupon number. For some special coupons, the coupon website may limit the number of times for downloading and printing by the user. For example, for the coupons which need to be redeemed by point deduction, the coupons stored by the user in “My Coupon”, some coupons which are provided to senior users of the website, and so on, the numbers of the above coupons may be particularly identified in the database of the background process system. For example, the number of an ordinary coupon may be constitute of numeric characters purely (09090201234), while for the above special coupons, in addition to the numeric characters, English letters may be added (0909021234P), special characters may be added (0909021234X11), and so on. Further, after searching for the coupon, the background process system may identify the coupon number and judge whether there exist non-numeric characters. One of ordinary skill in the art appreciates that, the procedure may be realized by functions for intercepting characters in the database and detailed descriptions thereof are omitted. Then, the number of pieces of the coupons which may be provided is determined according to the judgment result, and the number of times for downloading the coupon may be displayed on the display screen for prompting the user.

Further, the coupon terminal may have more humanized settings for downloading the coupons. For example, the downloading at the terminals positioned at exits of subway stations may be set as within some particular time periods. For example, during rush hours and lunch and dinner time periods, usually, many users download and print coupons at a terminal, and then in order to avoid excessively long waiting time of the users in queue, the terminal may limit the number of times for downloading and printing coupons by users during the above time periods. For example, a maximum of three pieces are allowed to be printed for every coupon, or the kinds of the coupons printed every time cannot go beyond five, and so on. Specifically, one of ordinary skill in the art appreciates that, the function may be realized by performing related settings in the background process system, and detailed descriptions thereof are omitted.

On the other hand, when the user does not belong to the first group, i.e., the judgment result of the step S221 is negative, step S224 is performed to read the coupon number included in the request information. Specifically, this step is analogous to the above step S222, in which the background process system of the coupon terminal reads the included coupon number information according to the coupon information stored by the user in “My Coupon” or according to the information of one or more businesses selected directly on the terminal by the user. The difference is that, the coupon information that does not belong to the first group needs to be selected from the background database. Further, a second group, a third group, etc. may be differentiated. For the procedure, the method in the above step S222 for selecting the first group may be referred to, and detailed descriptions thereof are omitted.

Then, step S225 is performed to determine one or more second coupons according to the coupon number. Specifically, the second coupons are provided to the user according to the search result in the above step S224. Further, the background process system may determine the number of times for downloading and printing the second coupons by referring to the method in the above step S223 in the same way, and detailed descriptions are omitted. One of ordinary skill in the art appreciates that, the second coupons usually differs from the first coupons; for example, the first coupons are dedicated to the users in a particular data list, for example, QQ members, senior users on the coupon websites, and so on; the second coupons are provided to all users, including ordinary users, for example, any user registered on the coupon website may obtain the second coupons. Further, for the coupons launched by the same business, for example, “buy one get one for free” series coupons launched by Barbera, the business may set the coupons that gives back more money to users in this series as the first coupons. For example, a coupon having the contents “buy a supreme pizza valued at Y-30 and get a pizza valued at Y-19 for free” may serve as a first coupon, and a coupon having the contents “buy a supreme pizza valued at Y-30 and get a salad valued at Y-5 for free” may serve as a second coupon. Specifically, businesses may set different coupons as the first coupons and the second coupons according practical conditions, and detailed descriptions thereof are omitted.

One of ordinary skill in the art appreciates that, in a modified example of the step S220, request information for obtaining a coupon sent from a third party system may also be received. Specifically, for example, the third party system may be information process systems corresponding to one or more advertisers who place advertisements on the coupon terminal. Specifically, the background process system of the coupon terminal may open certain data access permissions to the information process systems of the advertisers so that the advertisers may send request information for obtaining coupons of the businesses that the advertisers serve to the background process system by the information process systems used by the advertisers. One of ordinary skill in the art appreciates that, in the database of the background process system, database developers may create different data tables for different businesses, and the advertiser for every business may only access the data table of the business that the advertise serves and send the request information for obtaining a coupon to this business. Further, the advertisers may send new coupon information to corresponding data tables in the background process system by the information process systems. The above procedure may be completed by database statements and detailed descriptions are omitted. One of ordinary skill in the art appreciates that, advertisers are the main bodies for releasing advertisements, for example, Yum Brands needs to separately release advertisement information for “KFC” and “Pizza Hut”, and the advertisers hope to maintain the advertisement information by themselves. Thus, docking may be completed by the information process systems maintained by the advertisers and the background process system. Further, one of ordinary skill in the art appreciates that, in a modified example of the step S220, the background process system is a background service system for maintaining the coupon terminal. For example, the background service system directly sends a variety of operation instructions to the coupon terminal, and the background service system and the coupon terminal belong to the same service provider, for example, a service provider dedicated to providing the coupon terminal. In a modified example of the step S220, the request information may come from independent third party systems other than the background service system provided by the coupon terminal service provider and the information process systems provided by advertisers. For example, the third party systems may be internal systems of an advertisement service provider, e.g., an advertisement agency. For another example, the third party systems may also be information managing systems which are independent from the coupon terminal service provider but provide coupon information service or member management service. Detailed descriptions thereof are omitted.

One of ordinary skill in the art appreciates that, in the step S220, the procedure of the mobile terminal sending the request information may be realized by other manners. For example, the coupon website may provide a short message platform for users so that users may send the request information for obtaining a coupon in a way of editing short messages. One of ordinary skill in the art appreciates that, firstly, the coupon website may open a short message service platform and provide a service code (e.g., 10098), a user may send the number of a required coupon to the short message service code (10098) by editing short messages; in addition, a platform capable of receiving the short messages (i.e., the sent request information for obtaining a coupon) sent by the user is needed at the background process system side, and upon receipt of the short messages, the user's required coupon may be searched for according to the information contents of the short messages; further, when the user needs to obtain the information of more coupons, he may edit information similar to “09091208**” and send it to the service code; upon receipt of the information, the background process system may search for all coupons beginning with “09091208” by fuzzy database query. This does not influence the substantive contents of the present invention. One of ordinary skill in the art may dream up more implementation manners by modifying the above steps using prior arts. For example, sending an email to a fixed address by a mobile terminal may be employed, for example, sending to an email address of a coupon service provider by using a blackberry mobile phone; alternatively, the step S220 may be completed by a mobile terminal logging into QQ and sending particular information, e.g., “XX coupon” (e.g., “KFC coupon”), to a particular number (e.g., “5621380”). Detailed descriptions thereof are omitted.

Further, one of ordinary skill in the art appreciates that, the above step S220 and its modified examples may be applied into the step S210 in the above FIG. 1 to receive the request information for obtaining a coupon, i.e., this step may be modified by referring to S220. This does not influence the substantive contents of the present invention, and detailed descriptions thereof are omitted.

Further, in another modified example of the present embodiment, it can be seen that the step S222 is analogous to the step S224, i.e., in both of which the coupon number included in the request information is read, and thus the two steps may be incorporated into one step in the above procedure, and the incorporated step may be before the step S221. After sequence changes, the information of coupon number is firstly read from the request information for obtaining a coupon sent by the user, and then it is determined whether the requester corresponding to the request information belongs to the first group. One of ordinary skill in the art appreciates that, such change does not influence the substantive contents of the present invention.

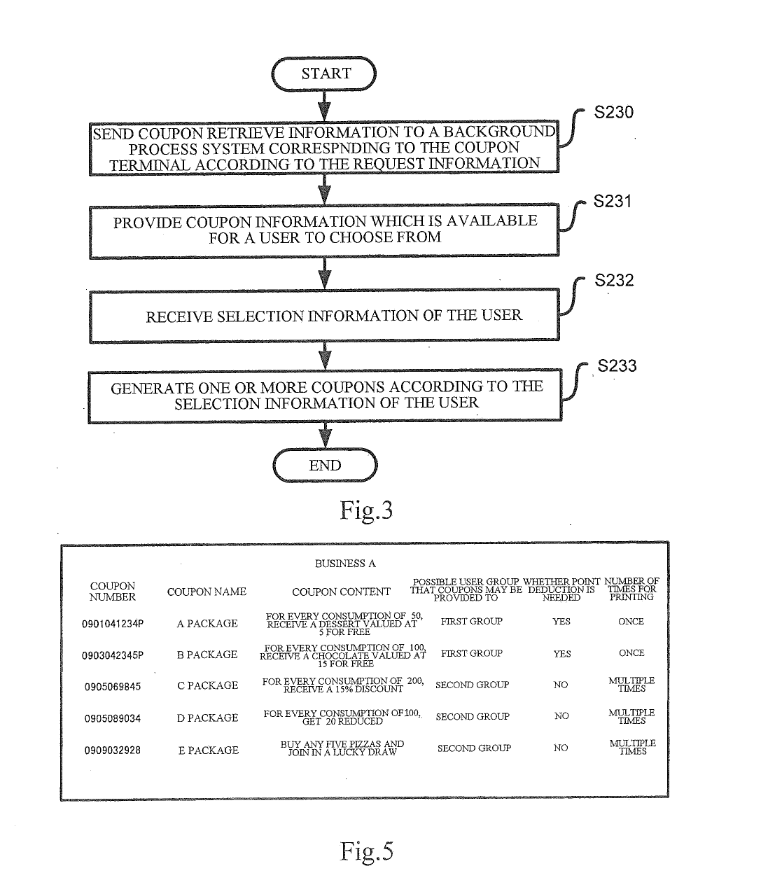

FIG. 3 illustratively depicts a flowchart of a control method for obtaining a coupon by a coupon terminal according to a third embodiment of the present invention. The present embodiment is a specific implementation procedure for generating one or more coupons according to the request information. Specifically, step S230 is firstly performed to retrieve, from the coupon terminal, coupon information which is available for a user to choose from according to the request information. For example, when the user puts the electronic tag card in the sensing area of the coupon terminal for identification, the background process system may read information of the user in the electronic tag card, including the information such as the user's account, remaining points in the account, the group that the user belongs to. Further, when the user selects the “My Coupon” key on the terminal or directly selects the keys corresponding to one or more businesses on the terminal, the background process system judges according to the obtained information of the user together with the request information for obtaining a coupon sent by the user, and searches the database according to the judgment result and retrieves coupon information which is available for the user to choose from. For example, based on the obtained information of the user, it is concluded that the user belongs to a first group and the user selects to obtain the coupons stored in “My Coupon”. The background process system then firstly obtains the coupon information stored by the user in “My Coupon”, and retrieves, from the obtained coupon information, first coupons which may be provided to the users in the first group. Specifically, one of ordinary skill in the art appreciates that, the above procedure may be realized by the coupon terminal and corresponding background process system, the background process system receives request information transmitted from the coupon terminal, searches the database using query statements for coupon information satisfying criterion, and displays the coupons on display screen of the terminal. For specific procedure, please refer to the embodiments in FIGS. 1 and 2, and detailed descriptions thereof are omitted.

In a modified example of the step S230, it is a second preference that the coupon terminal may also broadcast the coupon information which is available for a user to choose from by a voice broadcasting means. One of ordinary skill in the art appreciates that, the voice broadcasting means may be mounted on the coupon terminal, and the apparatus is associated with the background process system to feed process results of the background process system back to the user by voice information; further, the coupon terminal may also prompt the user to complete the whole operation procedure for obtaining a coupon by using the voice means. This does not influence the substantive contents of the present invention, and detailed descriptions thereof are omitted.

Then, step S231 is performed to provide coupon information which is available for the user to choose from. For example, the coupon information available for the user to choose from may include that distances between locations of consumption places corresponding to the coupon and the coupon terminal are less than a first threshold. The first threshold may be set by the background process system of the coupon terminal. For example, the first threshold may be set as 1 kilometer, i.e., distances between the consumption places corresponding to the coupons and the coupon terminal are within 1 kilometer. One of ordinary skill in the art appreciates that the coupon website may determine specific geographical locations of its respective coupon terminals and may obtain specific geographical locations of respective consumption places where the businesses are located from the information process system of respective businesses; further, technicians may use prior map search tools (e.g., Google map, ddmap, and so on) to mark the graphical locations of all the coupon terminals and respective consumption places on the maps, measure the distances between the above geographical locations using the tools provided by the maps, record the measured distance values in the database of the background process system, and then select the consumption places which are within 1 kilometer away from the coupon terminal. In addition, a second threshold and a third threshold may be set as well. For example, the second threshold may be set as 2 kilometers, the third threshold may be set as 3 kilometers, and so on, and the coupons of corresponding consumption places may be selected using the above method in the same way. For another example, longitudes and latitudes of the businesses and the coupon terminals determined by geographical location information system such as GPS may be recorded in the coupon terminal or a background process system corresponding to the coupon terminal so as to determine the distances between the both. Further, one of ordinary skill in the art appreciates that, when a user takes a mobile phone as an access terminal, the location of the user may be determined by base stations that the mobile phone corresponds to, and thus the coupon information matching the areas where the user is may be determined. Detailed descriptions thereof are omitted herein.

In a modified example of the step S231, the first threshold may be defined by the user. Specifically, the user adds corresponding distance values when sending the request information for obtaining a coupon. For example, if the user hopes that the consumption places corresponding to the coupons are within 500 meters away from the coupon terminal, he may enter 500 meters in an input box. One of ordinary skill in the art appreciates that, a corresponding input interface may be provided on the coupon terminal for the user to input values; after determination of the values, the user may send the values together with the request information for obtaining a coupon to the background process system, and then the background process system selects the coupons according to the obtained distance values. The above procedure may be realized by functions related to data query and data selection, and detailed descriptions thereof are omitted.

Then, step S232 is performed to receive selection information of the user. Specifically, after the background process system provides the selected coupon information to the user, he may view the specific information of every coupon on the coupon terminal and may further select required coupons. After the user pressing the “Print” key, the coupon terminal sends the instruction of the user to the background process system. In addition, if the user prefers not to print the coupon for now, he may select to send the coupon to “My Coupon” in the electronic tag card. For the specific procedure, please refer to the embodiment in FIG. 1, and detailed descriptions thereof are omitted. Then, the background process system receives the selection information of the user sent by the terminal.

Next, step S233 is performed to generate one or more coupons according to selection of the user. Specifically, upon receipt of the selection information of the user, the background process system may further select the coupon by database query using the selection information as judgment conditions, and feed the selected results back to the user. For example, if the user selects to print the coupon, then the background process system automatically starts printing function to print the coupon at the terminal. For another example, if the user selects to send the coupon to “My Coupon” account in the electronic tag card, then the background process system records the coupon information in the account of the user by database operation, and displays prompt information regarding completion of the operation on the coupon terminal.

Referring to the FIG. 3, one of ordinary skill in the art may realize the step of “providing the user the coupons corresponding to consumption places whose locations are separated from the coupon terminal by a distance less than a first threshold” in the above step S231 by many manners in combination with prior arts. Preferably, a data table, which records information regarding all the consumption places which are separated from the geographical location of the coupon terminal by a distance less than the first threshold, may be set in the coupon terminal, and the requesters having distance and location requirements may be accordingly provided with the coupons corresponding to consumption places satisfying the first threshold requirement (if all requesters have such requirements, then only the coupons corresponding to consumption places satisfying the first threshold requirement are provided). In such embodiments, every coupon terminal respectively maintains one data table having geographical location information.

Referring to the above FIGS. 1-3, one of ordinary skill in the art appreciates that, the coupon information involved in the above embodiments and displayed on the coupon terminals, or the coupon information sent to the mobile terminal, or the feedback information sent from the background process system to the coupon terminal and including the coupon information may be determined by many manners. For example, in a modified example of the above embodiment, preferably, a background process system corresponding to the coupon terminal may select one or more pieces of coupon information matching the coupon retrieve information from all the coupon information which may be obtained by the background process system. That is, the coupon terminal determines the coupon retrieve information according to the user's selection or according to other conditions (e.g., other factors other than the user's selection, e.g., the location of the coupon terminal, the time when the user sends the request, and so on) and sends the coupon retrieve information to the background process system. Accordingly, one of ordinary skill in the art appreciates that, upon obtaining the coupon retrieve information, the background process system searches all the coupon information by database query (may also be obtained from third party systems and this does not influence the substantive contents of the present invention), and further, the background process system screens all the coupon information according the coupon retrieve information and selects the coupon information matching the coupon retrieve information and sensd the selected coupon information to the coupon terminal. For example, the coupon information may be sent to the coupon terminal as the feedback information, or the coupon information may be directly displayed on the coupon terminal. This does not influence the substantive contents of the present invention. Further, one of ordinary skill in the art appreciates that, the procedure of selecting one or more coupons from all the coupon information may be realized by a variety of manners. For example, keywords (e.g., “KFC”, “Parkson Store”) included in the coupon retrieve information may be firstly determined, and then the coupons of KFC near the Parkson Store are selected preferably so as to make the coupon information meet user's practical requirements. For another example, the coupons of “Pizza Hut” which belongs to the same group with “KFC” may be selected and issued to the coupon terminal according to internal selection strategies. One of ordinary skill in the art may realize the procedure of selecting coupon information in combination with prior arts and the above embodiments and modified examples, for example, at least the technical solution provided in the Chinese Patent Application “METHOD AND APPARATUS FOR CHOOSING FROM A PLURALITY OF CANDIDAT ONLINE ADVERTISEMENT VERSIONS FOR ISSUING” (Application No. 200610148327.9). Detailed descriptions thereof are omitted.

In combination with the above modified examples, one of ordinary skill in the art appreciates that, during the procedure of selecting coupon information suitable for providing to the requester (the user) from a plurality of or all pieces of the coupon information, the geographical factors of the requester may be the major consideration. That is, after the requester sends the request information for printing a coupon, the coupon terminal or the background process system corresponding to the coupon terminal selects to issue the coupon information of the requester according to the geographical location of the requester, such as the embodiment shown in FIG. 2, and detailed descriptions thereof are omitted.

Further, one of ordinary skill in the art appreciates that, the coupons may be electronic coupon information. For example, after the user selects one or more coupons, for example, determining selected coupons according the embodiments or modified examples shown in FIGS. 1-3, the coupon terminal may send the coupon information to a user's mobile terminal by short messages (i.e., the coupon terminal sends corresponding coupon information to a mobile communication platform by a background service system corresponding to the coupon terminal, e.g., a short message process system provided by China Mobile, or the coupon terminal directly sends the coupon information to the mobile communication platform) or Bluetooth, and further, the user may view the coupon information by the mobile terminal. Or, the coupon terminal may also write the coupon information into the mobile terminal based on RFID protocols, for example, into a corresponding RFID card included in the mobile terminal.

Further, referring to the embodiments shown in FIGS. 1-3, one of ordinary skill in the art appreciates that, the control procedure for providing coupons may change depending on different implementation requirements. For example, in a modified example of the embodiment shown in the above FIG. 1, between the step S211 and the step S212, if the judgment result of the step S211 is positive, a process procedure for verifying the identity of the user who is operating the coupon terminal may be performed. Similarly, for another example, in a modified example of the embodiment shown in the above FIG. 3, between the step S232 and the step S234, it is also preferable to perform the process procedure for verifying the identity of the user who is operating the coupon terminal. Specifically, the verifying procedure is as follows. For example, prompt information is sent to the user by the display screen to prompt the user to provide identity verification information, and further, subsequent operations are performed according to whether the user provides correct verification information, such as what mentioned below. Preferably, the identity verification information may be indication information of a user equipment corresponding to the coupon terminal, or may be identity information of the user recorded in a background service system adaptive with the coupon terminal.

Specifically, for example, the user is prompted to put the electronic tag card near a sensing equipment on the coupon terminal. Further, the sensing equipment reads the information in the electronic tag car by a radio frequency network, i.e., verifying the identity of the user, wherein the ID of the electronic tag serves as the identity verification information. For specific procedure of reading information, please refer to the embodiments in FIG. 1 or 3. Detailed descriptions thereof are omitted.

For another example, the user may be further prompted to enter a serial number of the electronic tag card by an input apparatus on the coupon terminal. Further, the user may be prompted to enter the mobile phone number or identity number, social security card number, passport number by the input apparatus on the coupon terminal. One of ordinary skill in the art appreciates that, the mobile phone number is actually attached with the serial number of the electronic tag card when the user activates the electronic tag card, and thus the sensing equipment of the coupon terminal may complete the verification procedure by the serial number or the mobile phone number. For example, when the coupon terminal has verification information stored therein, the verification procedure may be completed directly by the coupon terminal. For another example, the identity verification request information may be sent by the coupon terminal to the background service system corresponding to the coupon terminal, and the identity verification procedure may be completed by the background service system. Specifically, one of ordinary skill in the art appreciates that, the identity verification information provided by the user (consumer) needs to match the verification information stored in a database or other storage apparatus so as to pass the identity verification. For example, when the provided identity verification information exists in one verification database, it is considered that the identity verification is passed. One of ordinary skill in the art may realize the verification procedure in combination with prior arts, and detailed descriptions thereof are omitted.

Further, if the coupon terminal determines that the above identity verification has been passed, the step S212 in FIG. 1 or the step S234 in FIG. 3 is performed. For example, the coupon terminal directly performs verification, or the background service system corresponding to the coupon terminal performs verification and sends verification results to the coupon terminal. Specifically, the embodiment of corresponding steps in FIG. 1 or 3 may be referred to, and detailed descriptions are omitted.

Further, one of ordinary skill in the art appreciates that, in such modified examples, an initial request for a coupon is merely initiated in the step S210 in FIG. 1, i.e., pressing a key to start selection of coupon information. The manners of pressing a key or operating touch screen may be considered as the above step S210 or the similar step S230 in FIG. 3. Detailed descriptions thereof are omitted.

Further, one of ordinary skill in the art appreciates that, by the embodiments in FIGS. 1 and 3 and the present modified example, actually, two different operations for providing a coupon by a coupon terminal may be realized. For example, a user may firstly conduct identity verification, or provide his identity to the coupon terminal, and then select coupons until obtain coupons. For another example, a user may select coupons firstly, and after determining that he needs to obtain coupons, he may conduct identity verification operation, or provide his identify information to the coupon terminal, and thus it is avoided to perform identity verification operation (an unnecessary operation) while obtaining a coupon is abandoned. Further, one of ordinary skill in the art appreciates that, in any one of the above cases, the procedure of providing identity information may be omitted according to a further modified example and this does not influence the substantive contents of the present invention. One of ordinary skill in the art appreciates that, providing identity information is helpful in background service system organizing download information of coupons, and convenient in statistics, analyzing and subsequent deep level applications.

FIG. 4 depicts a network topology for obtaining a coupon by a coupon terminal according to a specific embodiment of the present invention. Specifically, the network topology includes a coupon terminal 61, a coupon terminal 62, and a coupon terminal 63. In practical application situations, there should be a plurality of coupon terminals and only three are presented in this figure for illustration. The network topology further includes a mobile terminal 64. In practice, there should be a plurality of mobile terminals. The mobile terminals further include a radio frequency module which has unique identification information. One of ordinary skill in the art appreciates that, taking a mobile phone as an example, a user may attach a SIM card number with the radio frequency module so that the user may obtain coupons at respective coupon terminals using the mobile phone after he successfully registers on a coupon website by the mobile phone number. In addition, the coupon terminals are connected with a corresponding background process system 68. In practical application, every coupon terminal may corresponds to a respective background process system, the background process systems are associated with each other and then connected to a general background process system. Or, a plurality of coupon terminals within a certain geographical scope may share one background process system. One of ordinary skill in the art may select an optimal connection manner according to specific situations and data process efficiency, and detailed descriptions thereof are omitted.

For example, a user may put an electronic tag card or the mobile terminal 64 (e.g., a mobile phone) having a radio frequency function near the sensing area of a coupon terminal (61 or 62 or 63), and the coupon terminal may read data information in an access card (e.g., an RFID card) or the mobile terminal of the user by a radio frequency network. After the completion of reading data information, the user may select the “My Coupon” key on the coupon terminal, and then the background process system 68 reads coupon information stored by the user in “My Coupon” and displays the read results on a display screen of the coupon terminal; the user may select to print any one or more of the coupons, or he may select to send the coupons to the electronic tag card, and upon receipt of the request information for obtaining a coupon from the user, the background process system judges according to the user's information and the request information for obtaining a coupon and then generates one or more coupons which may be provided to the user. For another example, the user may directly select key(s) corresponding to one or more businesses on the coupon terminal, then the background process system searches data tables corresponding to the businesses in the database according to the selection information of the user, reads coupon information in the data tables and displays the coupons which may be provided to the user on the display screen of the terminal; the user selects, from the displayed ones, the coupons which need to be printed or need to be downloaded to the electronic tag card; upon receipt of the request information, the background process system performs related operations to generate one or more coupons. For the above specific procedure, please refer to the specific embodiments in FIGS. 1, 2, 3, and detailed descriptions thereof are omitted.

In addition, the network topology further includes a base station 66, a background process system 69 of the coupon website and a third party system 67. Specifically, the mobile terminal 64 may log into the coupon website by a web-surfing capability of a mobile communication module in the mobile terminal 64, and the user may search directly on the coupon website for the coupon information of businesses and store required coupon information in “My Coupon”. One of ordinary skill in the art appreciates that, the procedure may be realized by the background process system 69 of the coupon website; upon the user's click on an “Add into My Coupon” option near the coupon, the background process system 69 receives the request information for obtaining a coupon and then adds the coupons selected by the user into the “My Coupon” account. Preferably, a maximum of 30 pieces of coupons may be stored in the user's account. Specifically, website developers may write corresponding scripting languages for the operation options to realize the procedure. Detailed descriptions thereof are omitted.

Further, the third party system 67 may also communicate with the background process system 69 of the coupon website. Here, the third party system may include information process systems corresponding to one or more advertisers who place advertisement information on the coupon terminal. Specifically, the background process system 69 of the coupon website may open certain data access permissions to the information process system 67 of the advertisers so that the advertisers may send the request information for obtaining the coupons of the business that the advertisers serve to the background process system by the information process systems. One of ordinary skill in the art appreciates that, in the database of the background process system, database developers may create different data tables for different businesses, and the advertiser for every business may only access the data tables of the business that the advertiser serves and send the request information for obtaining a coupon to this business. Further, the advertisers may send new coupon information to corresponding data tables in the background process system by the information process systems. The above procedure may be completed by database statements and detailed descriptions thereof are omitted.

One of ordinary skill in the art appreciates that, preferably, the background process system 69 and the background process system 68 in the present embodiment may be the same system, for example, the same server, and detailed descriptions thereof are omitted.

One of ordinary skill in the art appreciates that, the “My Coupon” function may preferably be an item which is provided by the coupon service provider for users, and users may store contents such as their required coupon information, coupon request information and coupon numbers in this item. For example, preferably, the background process system 68 or background process system 69 stores “My coupons” of every user by a data table in the database maintained by the background process system 68 or background process system 69 itself, i.e., one piece of data record is added in the data table for every addition of one piece of coupon information in a private coupon account by the user. Preferably, the user's ID may be used to determine which user's “My Coupons” item the coupon information belongs to.

Further, one of ordinary skill in the art appreciates that, in the present embodiment, after the user sends the request information for obtaining coupon information to any terminal (e.g., the terminal 62) by the mobile terminal 64 (e.g., an RFID card), the terminal 62 may directly determine one or more pieces of coupon information according to the request information and send the coupon information to the user, for example, to the RFID card by RFID protocols; the coupon information which should be provided to the user may be determined by the background process system 68 sending request information for coupon information; the background process system 68 may also determine the coupon information independently or by cooperation with the third party system. This does not influence the substantive contents of the present invention and detailed descriptions are omitted. Further, one of ordinary skill in the art appreciates that, the communications of the background process system 68 or the background process system 69 or the third party system may be realized by mobile networks (e.g., the GPRS network provided by China Mobile Limited), or may be realized by the internet. This does not influence the substantive contents of the present invention and detailed descriptions are omitted.

FIG. 5 depicts a schematic of a data table for storing information in a background process system of the coupon terminal according to a specific embodiment of the present invention. One of ordinary skill in the art appreciates that, in the background process system of the coupon terminal, all the data information may be stored by a database, and this figure may be considered as one data table in the background database. Specifically, as shown in the figure, the data table records all coupon information of a business A, including coupon numbers, coupon names, coupon contents, possible user group that coupons may be provided to, whether point deduction is needed and number of times for printing. For example, when a user selects a key corresponding to the business A on the coupon terminal, the background process system searches the database for the data table of the business A, and determines coupons which may be provided to the user according to the user's request information. For example, if the user belongs to a first group, the background process system may, according to the condition, select the coupons satisfying the condition from the coupons in the data table. Specifically, this may be realized by data query statements. For example, the following statements may be written: select field name 1, field name 2, . . . , field name N from ‘business A’ where the possible user group that coupons may be provided to=‘first group’, and then coupons with coupons numbers “0901041234P” and “0903042345P” may be selected according to the depicted data table. Further, the background process system may also determine the number of times for printing the coupons according to the coupon numbers. For example, both of the coupons with numbers “0901041234P” and “0903042345P” include a non-numeric character P, then the coupons may be printed only for once, and the background process system displays the information regarding the number of times for printing on the display screen. When the user exceeds the above number of times for printing, the background process system sends prompt information.

For another example, upon the user's selection of the “My Coupon” key on the coupon terminal, the background process system reads the coupon information stored by the user in an access card, and preferably, the background process system searches the database for corresponding coupons according to the coupon numbers. For example, the user stores a coupon of the business A with a coupon number “0905089034” in “My Coupon”, and then the coupon may be searched for from the data table of the business A according to the number by using the following database query statements: select * from database name where coupon number=‘0905089034’. One of ordinary skill in the art appreciates that, the above procedure of storing coupon numbers in “My Coupon” so as to store the coupon may be realized by many manners. For example, the user may select a required coupon on the coupon website and store its corresponding coupon number in the access card, and further, he may directly print this coupon just by making the access card sensed at the coupon terminal.

Further, other information (not shown in this figure) may be included in the data table, for example, expiration date of every coupon, whether the coupon is exclusive for QQ members, geographical locations of consumption places, and so on. Specifically, database operators may add related fields in the data table to add the above information. This does not influence the substantive contents of the present invention, and detailed descriptions thereof are omitted.

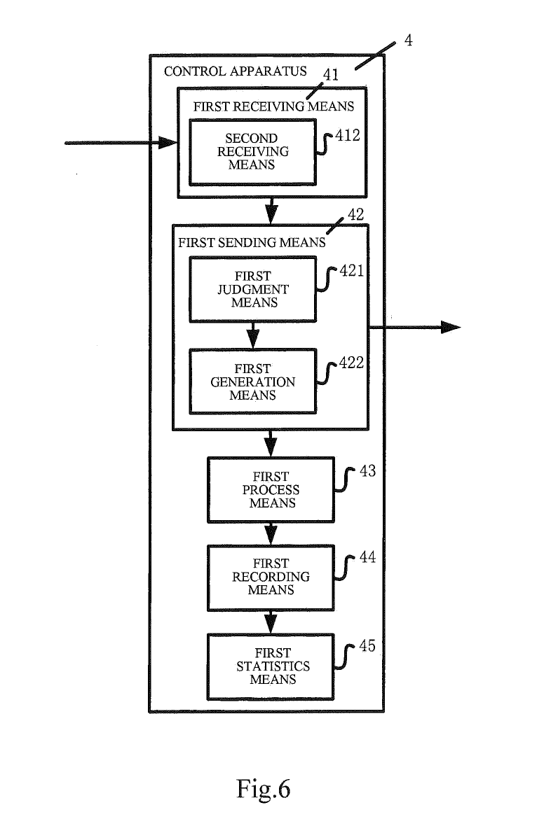

FIG. 6 shows a structure diagram of a control apparatus for obtaining a coupon by a coupon terminal according to a specific embodiment of the present invention. Specifically, the control apparatus 4 includes a first receiving means 41, a first sending means 42, a first process means 43, a first recording means 44 and a first statistics means 45. The means 41 is configured to receive request information for obtaining a coupon, and the means 42 is configured to provide a coupon according to the request information. Further, the means 41 further includes a second receiving means 412 configured to receive the request information for obtaining a coupon sent from a mobile terminal, or a third receiving means (not shown in this figure) configured to receive the request information for obtaining a coupon sent from a third party system. Specifically, the receiving manner of the means 41 may be determined according to specific situations. For example, the request information for obtaining a coupon sent from a mobile terminal may be received by the means 412. Taking a mobile phone with a radio frequency function as an example, one of ordinary skill in the art appreciates that, a SIM card number may be attached with the radio frequency apparatus, and then, when the user registers on corresponding websites or coupon terminals that provide coupon printing services using the mobile phone number, he may conduct identification at the coupon terminal by the radio frequency module in the mobile phone. When the coupon terminal completes information reading, the user may select any one or more businesses on the terminal, i.e., sending the request information for obtaining a coupon to a background process system, and then the background process system reads the coupon information of the businesses in the database and displays it on a display screen. For another example, the request information for obtaining a coupon sent from a third party system may be received by the third receiving means. The third party system may be information process systems corresponding to one or more advertisers who place advertisements on the coupon terminal. Specifically, the background process system of the coupon terminal may open certain data access permissions to the information process systems of the advertisers so that the advertisers may send the request information for obtaining the coupons of the business that the advertisers serve to the background process system by the information process system.

Further, the means 42 further includes a first judgment means 421, a first generation means 422 or a second generation means (not shown in this figure). The means 421 is configured to judge whether a requester corresponding to the request information belongs to a first group, the means 422 is configured to generate one or more first coupons according to the request information when the judgment is positive, or one or more second coupons may be generated by the second generation means according the request information. Specifically, the first group here may be defined by the coupon website itself. For example, all the users registered on the website may be classified, preferably according to points in the accounts of users. For example, users with a points value in account greater than or equal to 10,000 may be divided into a first group, users with a points value in account greater than or equal to 5,000 but less than 10,000 may be divided into a second group, and users with a points value in account less than 5,000 may be divided into a third group, and so on, and in the database of the background process system, all the users may be identified according to the above classification. When a judgment result of the judgment means 421 is positive, the means 422 is invoked to determine the first coupons which may be provided. The coupon website may limit the number of times for printing and downloading some particular coupons by the user. For example, for the coupons which need to be redeemed by point deduction, the coupons stored by the user in “My coupon”, some coupons which are provided to senior users of the websites, the numbers of the above coupons may be particularly identified in the database of the background process system. When the judgment result of the judgment means 421 is negative, the second generation means is invoked to determine the second coupons which may be provided. Specifically, the businesses may set different coupons as the first coupons and the second coupons according to practical situations, and detailed descriptions thereof are omitted.

Further, the means 43 is configured to deduct points corresponding to the provided coupon from an account corresponding to the request information, the means 44 is configured to record the provided coupon in the database, and the means 45 is configured to perform a statistical analysis on the provided coupon in the database. Specifically, the means 43 corresponds to some special coupons. For example, coupon website launches some coupon packages which need to be redeemed by point deduction, and when the user selects to print the coupons or to send the coupons to his electronic tag card, the background process system of the coupon terminal may deduct corresponding points from the user's electronic tag card account according a preset points value required for obtaining the coupon. Then, the provided coupon is adaptively recorded in the database by the means 44. Specifically, one of ordinary skill in the art appreciates that, every coupon has an unique number, and the coupons may be recorded in the database of the background process system according the numbers. In the end, the means 45 performs a statistical analysis on the provided coupons stored in the database. Specifically, in the database of the above step S214, every piece of coupon recording information may include a statistics field, i.e., 1 is added into the data in the statistics field every time the coupon is provided. For the above procedure, please refer to the specific embodiment in FIG. 1, and detailed descriptions thereof are omitted.

In a modified apparatus of the control apparatus, a second judgment means (not shown in the figure) is further included, which is configured to judge whether to provide a coupon according to the request information. Specifically, the second judgment means is positioned between the first receiving means 41 and the first sending means 42. Further, when the judgment result of the second judgment means is positive, the first sending means is invoked, whereas when the judgment result is negative, the first sending means is not invoked any more. Detailed descriptions thereof are omitted.

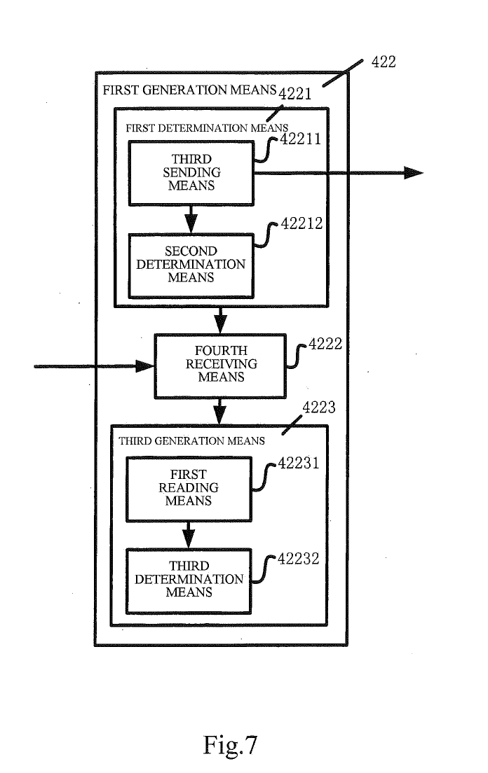

FIG. 7 depicts a detailed structure diagram of the first generation means (or the second generation means) in the control apparatus for obtaining a coupon by a coupon terminal according to a specific embodiment of the present invention. Specifically, the first generation means 422 according to FIG. 6 further includes a first determination means 4221 configured to determine, all coupon information which is available for a user to choose from according to the request information, a fourth receiving means 4222 configured to receive selection information of the user, and a third generation means 4223 configured to generate one or more coupons according the selection information of the user. Further, the means 4221 further includes a third sending means 42211 and a second determination means 42212, wherein the means 42211 is configured to send coupon retrieve information to the background process system corresponding to the coupon terminal according to the request information and the means 42212 is configured to determine and provide the coupon information which is available for the user to choose from according to feedback information of the background process system. Specifically, the means 42211 firstly sends the coupon retrieve information to the background process system corresponding to the coupon terminal according to the request information. For example, when the user puts the electronic tag card within the sensing area of the coupon terminal for identification, the background process system may read information of the user in the electronic tag card, including the information such as the user's account, remaining points in the account, the group that the user belongs to. Further, when the user selects the “My Coupon” key on the terminal or directly selects the keys corresponding to one or more businesses on the terminal, the background process system judges according to the obtained information of the user together with the request information for obtaining a coupon sent by the user, and searches for and retrieves coupon information which is available for the user to choose from by the means 42212 according to the judgment result.

Then, the selection information of the user is received by the means 4222. Specifically, when the background process system provides the selected coupon information to the user, the user may view specific information of every coupon on the coupon terminal, and further select required coupon, and when the user presses the “Print” key, the coupon terminal sends the user's instruction to the background process system; in addition, if the user prefers not to print the coupon for now, he may select to send the coupon to “My Coupon” in the electronic tag card. For specific procedure, please refer to the embodiment in FIG. 1, and detailed descriptions are omitted. Then, the background process system receives the selection information of the user sent by the terminal.

In the end, one or more coupons are generated by the means 4223 according to the selection information of the user, wherein the means 4223 further includes a first reading means 42231 configured to read a coupon number included in the request information and a third determination means 42232 configured to determine one or more coupons according to the coupon number. Specifically, the coupon number included in the request information is read by the means 42231. Preferably, the step may be applied into the situation where the user selects “My Coupon”. When the user selects the “My coupon” key on the coupon terminal, the background process system of the terminal reads the coupon information stored by the user in the access card. Specifically, the background process system reads the coupon number information and searches the database for corresponding coupons according to the number, and then one or more coupons are determined by the means 42232 according to the coupon number. Specifically, the coupon which may be provided is determined according to the search results the means 42231, the background process system may also determine the number of pieces that may be provided to the user according to the coupon number, and the coupon website may limit the number of times for printing and downloading some particular coupons by the user. For example, for the coupons which need to be redeemed by point deduction, the coupons stored by the user in “My coupon”, some coupons which are provided to senior users of the website, the numbers of the above coupons may be particularly identified in the database of the background process system. For example, the number of an ordinary coupon may be constitute of numeric characters purely (09090201234), while for the above special coupons, in addition to the numeric characters, English letters may be added (0909021234P), and special characters may be added (0909021234X11), and so on. Then, the number of pieces of the coupon that may be provided may be determined according to the judgment result, and the number of times for downloading the coupon may be displayed on the display screen for prompting the user. After receiving selection information of the user, the background process system may search the database to further select the coupons by taking the selection information as a judgment condition, and feed the selected results back to the user. For example, the user selects to print the coupon, the background process system automatically starts the printing function and prints the coupon from the terminal. For another example, the user selects to send the coupon to the “My Coupon” account in the electronic tag card, and the background process system may record the coupon information in the account the of user by database operation and display information for prompting the completion of the operation on the coupon terminal. For the above procedure, please refer to the specific embodiments in FIGS. 2 and 3, and detailed descriptions thereof are omitted.

Further, in a modified means of the second determination means 42212, a first display means (not shown in the figure) may further be included, which is configured to display the coupon information which is available for the user to choose from; or a first broadcasting means (not shown in the figure) may also be included, which is configured to broadcast the coupon information which is available for the user to choose from. Preferably, the coupon information which is available for the user to choose from may be displayed by the first display means, and the embodiment in FIG. 2 may be referred to and detailed descriptions are omitted. It is a second preference to play the coupon information which is available for the user to choose from by the first play means. One of ordinary skill in the art appreciates that, a voice broadcasting means may be mounted on the coupon terminal, and the means is associated with the background process system to feed process results of the background process system back to the user by voice information; further, the coupon terminal may also prompt the user to complete the whole operation procedure for obtaining a coupon by using the voice means. This does not influence the substantive contents of the present invention, and detailed descriptions thereof are omitted.

One of ordinary skill in the art appreciates that, the control method and the control apparatus provided by the present invention may be applied widely. For example, a coupon provider may provide coupon (printing) terminals at exits of subway stations, shopping malls, cinemas and stores, in an effort to make a user who uses the coupon terminals send a request for printing a coupon by an access terminal (e.g., an RFID card) matching the coupon terminals. For example, just by shaking such access terminal within the sensing area of the coupon terminal, identity identification can be completed by the electronic tag in the access terminal based on the RFID technology so that related information service may be provided according to user's requirements. For example, users may directly print coupons at terminals so that it is convenient for users to obtain coupons of businesses, anytime and anywhere.

Specific embodiments of the present invention are described above. It should be appreciated that, the present invention is not limited to the above particular implementations, and one of ordinary skill in the art may make modifications or amendments within the scope as claimed, which does not influence the substantive contents of the present invention.

1. A control method for obtaining a coupon by a coupon terminal, comprising the following steps:
a. receiving request information for obtaining a coupon;
i. judging whether to provide a coupon according to the request information;
ii. if a judgment result of the step i is positive, performing step b;
b. providing a coupon according to the request information.

2. The control method according to claim 1, wherein the step i comprises any one of the following steps:
judging whether a requester corresponding to the request information exists in a particular data list according to the request information, wherein the judgment result of the step i is determined as positive if the requester exists in the particular data list;
judging whether a requester corresponding to the request information belongs to a particular group according to the request information, wherein the judgment result of the step i is determined as positive if the requester belongs to the particular group;
judging whether a requester corresponding to the request information sends the request information for a plurality of times within a time period according to the request information;
judging whether a requester corresponding to the request information is a person in a particular age bracket according to the request information, wherein the judgment result of the step i is determined as positive if the requester is the person in the particular age bracket; and
judging whether a requester corresponding to the request information is of a particular gender according to the request information, wherein the judgment result of the step i is determined as positive if the requester is of the particular gender.

3. The control method according to claim 1, wherein the step b comprises the following steps:
judging whether a requester corresponding to the request information exists in a belongs to a first group according to the request information;
if the requester belongs to the first group, generating one or more first coupons according to the request information; and
if the requester does not belong to the first group, generating one or more second coupons according to the request information.

4. The method according to claim 1, wherein the step b comprises any one of the following steps:
generating one or more coupons according to the request information and printing the coupons; and
generating one or more electronic coupons according to the request information, and sending the electronic coupons to one or more terminals corresponding to the request information.

5. The control method according to claim 4, wherein the step of generating one or more coupons according to the request information comprises the following steps:
b1. providing, according to the request information, all coupon information which is available for a user to choose from
b2. receiving selection information of the user; and
b3. generating one or more coupons according to the selection information of the user.

6. The control method according to claim 5, further comprising the following steps between the step b2 and the step b3:
prompting the user to provide identity verification information;
judging whether the identity verification information is received, and performing the step b3 if the identity verification information is received.

7. The control method according to claim 6, wherein the identity verification information comprises at least any one or more kinds of the following information:
indication information of a user equipment corresponding to the coupon terminal; and
identity information of the user recorded in a background service system corresponding to the coupon terminal.

8. The control method according to claim 5, wherein the step b1 comprises the following steps:
sending coupon retrieve information to a background process system corresponding to the coupon terminal according to the request information;
determining and providing the coupon information which is available for the user to choose from according to feedback information from the background process system.

9. The control method according to claim 8, wherein the feedback information at least comprises an one kind of the following information:
information in the background process system regarding an appointed coupon in an account corresponding to the requester corresponding to the request information; and
coupon information which is selected from all coupon information in the background process system and matches the coupon retrieve information;
wherein the information regarding an appointed coupon in an account corresponding to the requester is held within the account corresponding to the requester by any one of the following manners:
the requester actively requesting the coupon;
a background process system pushing the coupon to the account corresponding to the requester; and
automatically obtaining the coupon when the requester submitting registration information;
wherein the coupon retrieve information comprises indication information regarding a location of the coupon terminal, and the feedback information at least matches the indication information.

10. The control method according to claim 8,
wherein the background process system comprises any one or more of the following systems:
a third party system;
information process systems corresponding to one or more advertisers placing advertisement information on the coupon terminal; and
the background service system configured to maintain the coupon terminal.

11. The control method according to claim 5, wherein the coupon information which is available for the user to choose from comprises the coupons corresponding to consumption places, locations of which are separated from the coupon terminal by a distance less than a first threshold.

12. The control method according to claim 4, wherein the step of generating one or more coupons according to the request information comprises the following steps:
b1′. reading a coupon number included in the request information;
b2′. determining one or more coupons according to the coupon number.

13. The control method according to claim 12, wherein the request information is sent by a mobile terminal, and the coupon number is downloaded to the mobile terminal in advance.

14. A control apparatus for obtaining a coupon by a coupon terminal, comprising:
a first receiving means configured to receive request information for obtaining coupon; and
a first sending means configured to provide a coupon according to the request information;
wherein the first receiving means further comprises any one of the following means:
a second receiving means configured to receive the request information for obtaining a coupon sent from a mobile terminal; and
a third receiving means configured to receive the request information for obtaining a coupon sent from a third party system.

15. The control apparatus according to claim 14, wherein the first sending means further comprises:
a first judgment means configured to judge whether a requester corresponding to the request information belongs to a first group according to the request information;
a first generation means configured to generate one or more first coupons according to the request information; and
a second generation means configured to generate one or more second coupons according to the request information;
wherein if a judgment result of the first judgment means is positive, the first generation means is invoked; and if the judgment result of the first judgment means is negative, the second generation means is invoked.

16. The control apparatus according to claim 14, wherein the first sending means further comprises any one of the following means:
a first printing means configured to generate one or more coupons according to the request information and print the coupons; and
a second sending means configured to generate one or more electronic coupons according to the request information, and send the electronic coupons to one or more terminals corresponding to the request information.

17. The control apparatus according to claim 14, further comprising:
a first process means configured to deduct points corresponding to the provided coupon from an account corresponding to the request information;
a first recording means configured to record the provided coupon adaptively in a database; and
a first statistics means configured to perform a statistical analysis on the provided coupon stored in the database.

18. The control apparatus according to claim 14, wherein the mobile terminal at least comprises a radio frequency module, and the radio frequency module has unique identification information.

19. The control apparatus according to claim 18, wherein the mobile terminal at least further comprises a mobile communication module, and the mobile communication module comprises any one of the following modules:
GPRS communication module;
Wi-Fi communication module;
WCDMA communication module;
TD-SCDMA communication module;
WiMax communication module; and
LTE communication module.

20-40. (canceled)
